(19) United States
(12) Patent Application Publication
(10) Pub. No.: US 2026/0192811 A1
(43) Pub. Date: Jul. 9, 2026

(54) DETAILED TRAIN MAKEUP FROM WAYSIDE WEIGHING IN MOTION SYSTEM

(71) Applicant: Transportation IP Holdings, LLC, Norwalk, CT (US)

(72) Inventors: Daniel Tuttle Spencer, Melbourne, FL (US); Adam Hausmann, Melbourne, FL (US)

(73) Assignee: Transportation IP Holdings, LLC, Norwalk, CT (US)

(21) Appl. No.: 19/012,538

(22) Filed: Jan. 7, 2025

(51) Int. Cl. B60W 50/02; B60W 50/14

(52) U.S. Cl. CPC B60W 50/0205; B60W 50/0225; B60W 50/14; B60W 2420/403; B60W 2530/10

(57) ABSTRACT

Methods and systems for evaluating detailed vehicle makeup (DVM) data associated with a vehicle system. A vehicle management server compares observed imaging data received from one or more wayside devices to the detailed vehicle makeup data. If the vehicle management server determines that the accuracy of the DVM data fails to meet an accuracy threshold associated with an expect value, it may notify a client and request new DVM data. The vehicle management server can generate new DVM data and request an updated drive profile associated with the new DVM data.

### TECHNICAL FIELD

The subject matter described herein relates to a method and system for evaluating load distribution in a vehicle system based on detailed vehicle makeup data received from a client device and data received from a wayside device.

### SUMMARY

In one aspect, the present disclosure provides a system, comprising: a sensor configured to capture vehicle imaging data indicative of a vehicle parameter for a plurality of vehicles; a control circuit for communicating with the sensor, wherein the control circuit is configured to: receive detailed vehicle makeup (DVM) data associated with the plurality of vehicles; receive the vehicle imaging data from the sensor; determine an expected vehicle parameter for at least one of the plurality of vehicles based on the vehicle imaging data and a vehicle parameter model; compare the expected vehicle parameter to the DVM data for a corresponding vehicle; and determine an accuracy of the vehicle parameter in the DVM data based on the comparison of the expected vehicle parameter to the DVM data.

In another aspect, the present disclosure provides a method comprising: receiving detailed vehicle makeup (DVM) data, wherein the DVM data comprises vehicle load data for a plurality of vehicles; receiving vehicle imaging data from a wayside device, wherein the wayside device is configured to capture the vehicle load data for the plurality of vehicles; determining an expected vehicle load for the plurality of vehicles based on the vehicle imaging data and a vehicle parameter model; and determining an accuracy of the vehicle load data in the DVM data based on a comparison to the expected vehicle load.

In yet another aspect, the present disclosure provides a method comprising: receiving detailed vehicle makeup (DVM) data, wherein the DVM data comprises a vehicle weight for a plurality of vehicles; receiving surface deflection data from a wayside device, wherein the wayside device is configured to capture the surface deflection data indicative of the vehicle weight; determining an expected vehicle weight for the plurality of vehicles based on the surface deflection data and a surface deflection model; and determining an accuracy metric of the vehicle weight in the DVM data for the plurality of vehicles based on the expected vehicle weight and a statistical threshold of the vehicle weight in the DVM data.

### BRIEF DESCRIPTION OF THE DRAWINGS

The subject matter may be understood from reading the following description of non-limiting embodiments, with reference to the attached drawings, wherein below:

FIG. 1 shows a vehicle data verification system comprising a sensor, vehicle management server, vehicle information repository, vehicle system, client device, and auxiliary server system, in communication through a vehicle management network, according to at least one aspect of the present disclosure.

FIG. 2 shows a vehicle data verification system comprising a wayside device generating surface deflection data associated with each of a plurality of vehicles in a vehicle system, according to at least one aspect of the present disclosure.

FIG. 3 shows a vehicle data verification system comprising a plurality of wayside device, located a plurality of different position along a route, generating surface deflection data associated with each of a plurality of vehicles in a vehicle system, according to at least one aspect of the present disclosure.

FIG. 4 shows a logic flow diagram for evaluating the accuracy of DVM data based on imaging data observed on a vehicle system, according to at least one aspect of the present disclosure.

### DETAILED DESCRIPTION

Detailed vehicle makeup (DVM) data or detailed train make (DTM) data may be used by other systems, such as an energy management system (e.g., TripOptimizer) to generate a driver profile that indicates speeds, acceleration, braking, based on the route (distance, elevation, degree of curves, grade/slope), vehicle parameters (engines, weight, length, load distribution), fuel efficiency. The driver profile considers the load and weight distribution in the vehicle system in conjunction with route characteristics to determine efficient diving characteristics for fuel efficiency and handling to ensure safe operation of the vehicle system. The DVM data comprises data that indicates the weight of each vehicle and the order of each vehicle in the vehicle system. If the DVM data is not accurate, the generated driver profile may not be fuel efficient, or worse, create unsafe for operating conditions. A driver profile that relies on inaccurate DVM data may create vehicle forces that result in vehicle separation or collision together due to coupler failures, or derailment from excess lateral forces.

Accordingly, the present disclosure describes, in some embodiments, a method and system for evaluating the accuracy of DTM data, updating DTM data if inaccuracies are detected, and providing a system response such as updating driver profiles generated with an energy management system (e.g., TripOptimizer).

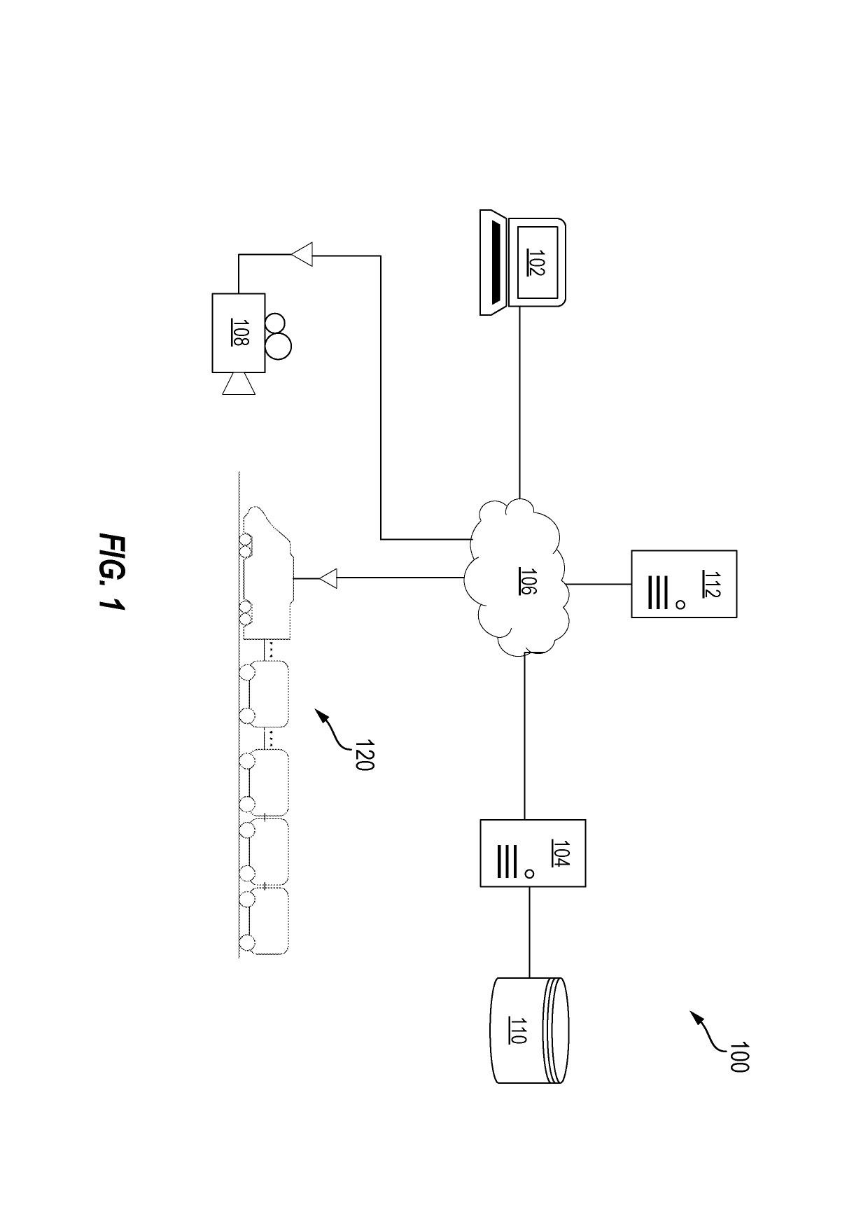

FIG. 1 shows a vehicle data verification system 100 that includes a sensor 108 (e.g., wayside device, camera, optical sensor), vehicle management server 104, vehicle information repository 110, vehicle system 120, client device 102, and auxiliary server system 112 (e.g., energy management system (EMS) server, positive vehicle control (PVC) server), in communication through a vehicle management network 106, according to at least one aspect of the present disclosure. The vehicle management server 104 and the auxiliary server may be part of the same system or may be different server systems. The servers may include one or more processors or control circuits communicably coupled to memory for executing command in the vehicle management network 106. The vehicle management server 104 (e.g., positive vehicle control (PVC) system, positive train control (PTC) system) may receive detailed vehicle makeup (DVM) from a client device 102. The detailed vehicle makeup (DVM) data may indicate a vehicle parameter such as the load status (e.g., loaded or unloaded) or weight of each vehicle, associated with a vehicle identifier and position, in the vehicle system 120. In various embodiments, the DVM may include data such as, carID 24: loaded; carID 33: unloaded; carID 24: 50,000 lbs.; carID 33; 10,000 lbs. The DVM data may be used by the EMS (e.g., tripOptimizer) to generate a driving profile, specific to the length and load distribution of the vehicle system and the route.

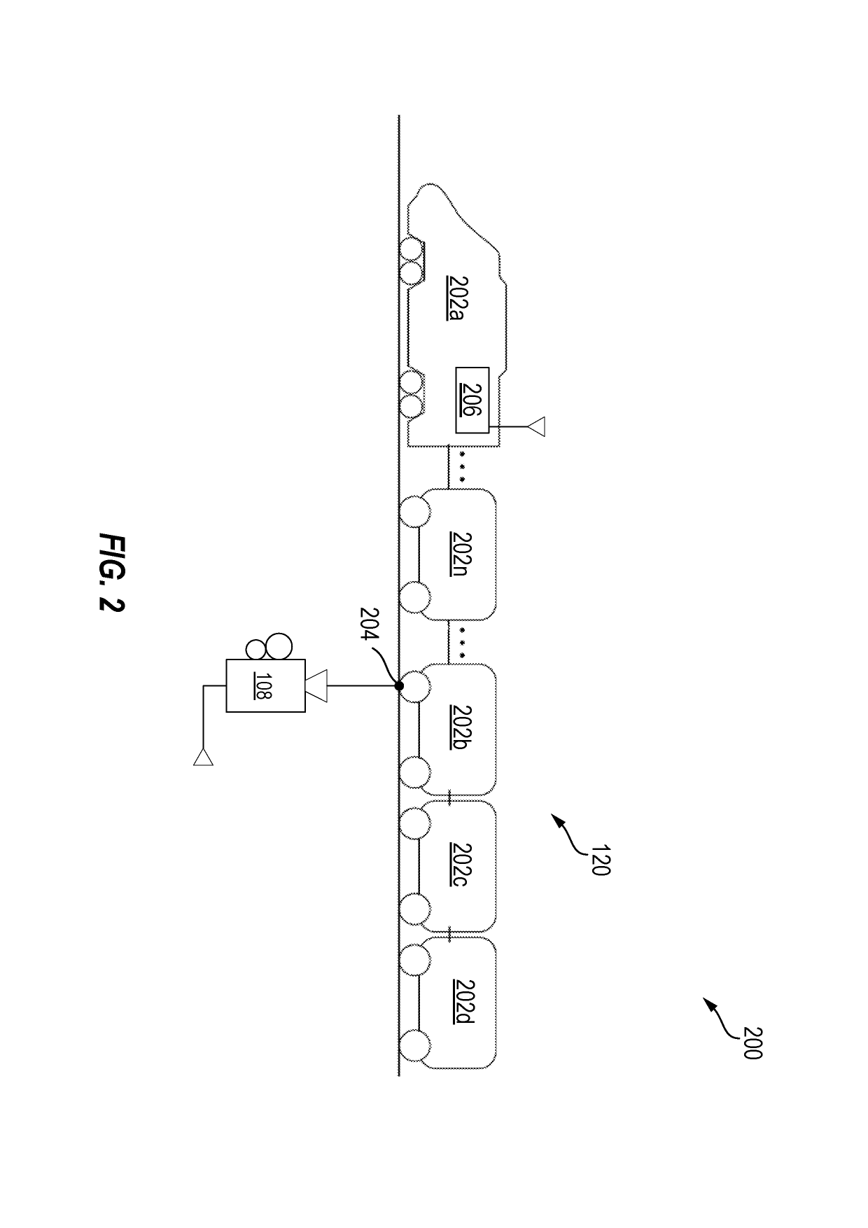

FIG. 2 shows a vehicle data verification system 200 that includes a wayside device 108 generating surface deflection data associated with each of a plurality of vehicles 202a-n in a vehicle system 120, according to at least one aspect of the present disclosure. The vehicle system 120 may include at least one propulsion vehicles (e.g., vehicle 202a) and a plurality of non-propulsion vehicles (e.g., vehicles 202b-n). However, the vehicle system may comprise of any number of vehicle configurations of propulsion, non-propulsion vehicles, order of vehicles, or quantity of vehicles. The propulsion vehicle 202a may include a control circuit 206 to communicate with the vehicle management network 106 and the vehicle management server 104. The wayside device 108 may be an optical sensor such as a camera or another light measurement device capable of capturing the physical displacement or deflection of a surface traversed by the vehicle system 120. In various aspects, the wayside device 108 is positioned so that the field of view that may capture the surface deflection associated with each axle of a vehicle system traversing a surface. The wayside device 108 may capture optical or imaging data, at a determined sampling frequency, for the surface deflection associated with each axle of the vehicle system 120. The wayside device 108 may transmit a real-time data stream of surface deflection data to the vehicle management server 108 or transmit batch data associated with the entire vehicle system 120. The wayside device 108 may be a high-resolution optical sensor that can differentiate millimeters or nanometers of displacement. The observed deflection data may require image processing to isolate and remove noise or image stabilization for vibrations, associated with vehicle system 120 as it passes along the surface.

The vehicle management server 104 may process the surface deflection data to determine whether the DVM, provided by the client device 102, accurately reflects the observed surface deflection for the vehicle system in operation. This analysis may show that a specific vehicle 202a-n in the vehicle system 120 is incorrectly identified by the DVM data as loaded or unloaded, the identified weight of a specific vehicle 202a-n greater than the identified weight in the DVM data by a determined threshold, the identified weight of a specific vehicle 202a-n less than the identified weight in DVM data by a determined threshold, or the vehicle order information is incorrect in DVM data, associated with a specific vehicle or vehicle range in the vehicle system. The vehicle management server 104 may further evaluate whether the observed number of vehicles in the vehicles system matches the number of vehicles identified in the DVM data.

The vehicle management server 104 may employ a plurality of models, based on the DVM data and the surface deflection data to determine a likely correction to specific vehicles in the DVM data. For example, the corrections may include: vehicleID 123 should be identified as loaded, vehicleID 123 has a weight between 50,000 lbs. and 60,000 lbs., vehicleIDs 123 – 132 are in the incorrect order, vehicleIDs 123 – 132 were not identified in the DVM data (e.g., DVM data was 10 vehicles short).

The measured surface deflection may be unique to specific conditions of the measurement location 204 based on various environmental factors including the age of the railroad tracks material composition, the ground composition under the railroad tracks, the speed and acceleration of a vehicle over the surface, and the weight of a specific vehicle directly over the measurement location on the railroad tracks. However, the measurement variability due to these environmental factors is controlled because all measurements for a vehicle system occur at the same measurement location 204 under the same conditions. Accordingly, the surface deflection displacement caused by the vehicle and measured by the wayside device 108 is directly proportional to weight of the vehicle. For example, if two vehicles have the same surface deflection, the vehicle management server may determine that the two vehicles have roughly the same weight distribution and overall weight. The vehicle management server 104 may also use various models (e.g., regression, distribution, trained neural network, law of averages, etc.) to correlate the observed deflection data (e.g., raw imaging data) to specific vehicle in the vehicle system (e.g., deflection of x mm correlates to vehicle ID 123).

The vehicle management server 104 may correlate the surface deflection displacement for each vehicle in the vehicle system based on the weight or load status of vehicle in the DVM as a first correlation dataset. In one example, each vehicle in the vehicle system has at least two axles. The vehicle management server 104 may evaluate adjacent axles to determine if they are part of the same vehicle or associated with a different vehicle based on the distance between axles, surface deflection, and DVM data. After the vehicle management server 104 correlates the observed deflection to a specific vehicle, it may correlate the observed deflection to a weight or status in the DVM data as a second deflection dataset. The vehicle management server 104 may generate a model for determining the expect vehicle parameter (e.g., deflection displacement/distance) based on the second correlation dataset and DVM data. The model may provide a range for the expected value based on a statically significant threshold (e.g., standard deviation, percent difference). In one example, the model may determine an expect value as an expected weight of the vehicle that is proportional or derived from the observed surface deflection. The vehicle management server 104 may then compares the expected deflection displacement, for each vehicle, to the observed deflection data for each of the plurality of vehicles in the vehicle system in the second correlation dataset. The vehicle management server 104 may determine whether the observed deflection data is within the statistical threshold range for the expect deflection displacement. If the observed deflection value is outside of the statistical threshold range, the vehicle management server 104 may determine that an error exists for a specific vehicle in the DVM data. The vehicle management server 104 may determine that the DVM data is under reporting the weight or over reporting the weigh for a specific vehicle based on being above or below a threshold range. Additionally, the vehicle management server 104 may determine that the position of identified vehicles in vehicle system 120 are reversed or rearranged. The vehicle management server 104 may suggest updated vehicle positions in DVM data, based on the models, rather than changing the weight or status information.

The vehicle management server 104 may perform various remediation actions in response to determining that the DVM data includes inaccurate information for the vehicle system including notifying the client device 102 or automatically updating the DVM data. The notification message may comprise the identified error for a specific vehicle in vehicle system, a suggested value based on the generative model, authorization to use the suggested values, and/or a request for new DVM data. The vehicle management server 104 may request an updated driver profile from the energy management system 112 based on the authorization of the suggested values or the new DVM data received from the client device 102. In another example, the vehicle management server 104 may automatically update the DVM data based on the generative model for vehicles associated identified error values. The new DVM data may replace the identified error values with generate weights, vehicle status, or vehicle position. The vehicle management server 104 may then request an updated driver profile from the energy management system 112 based the new DVM data. Once the vehicle management server receives the updated driver profile, it may then communicate the updated driver profile to the control circuit of the vehicle system 120. The vehicle data verification system allows the vehicle management server 104 to update a driver profile for the vehicle system 120, that is actively in operation.

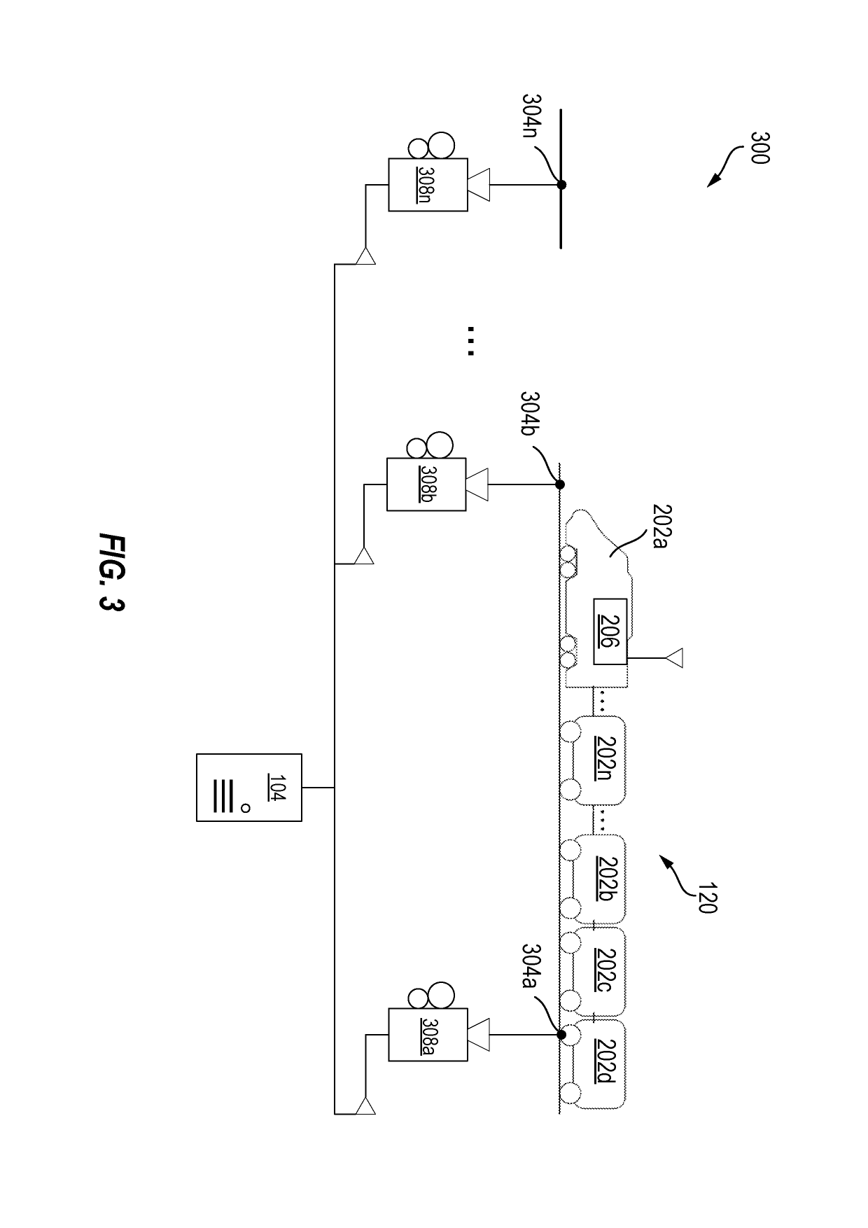

FIG. 3 shows a vehicle data verification system 300 that includes a plurality of wayside devices 308a-n, located at a plurality of different positions 304a-n along a route, according to at least one aspect of the present disclosure. The plurality of wayside devices 308a-n may be configured to generate surface deflection data associated with each of a plurality of vehicles 202a-n in a vehicle system 120. The surface deflection data associated with each of the plurality of locations 304a-n along the route may be communicated to the vehicle management server to process and evaluate the accuracy of the DVM data. In one example, the plurality of locations may allow the system 300 to generate more accurate models by verifying the accuracy of a model or controlling different variables at different locations. In another example, the deflection data from location 304a may be used to determine that new DVM data corrected the inaccuracies identified at location 304b.

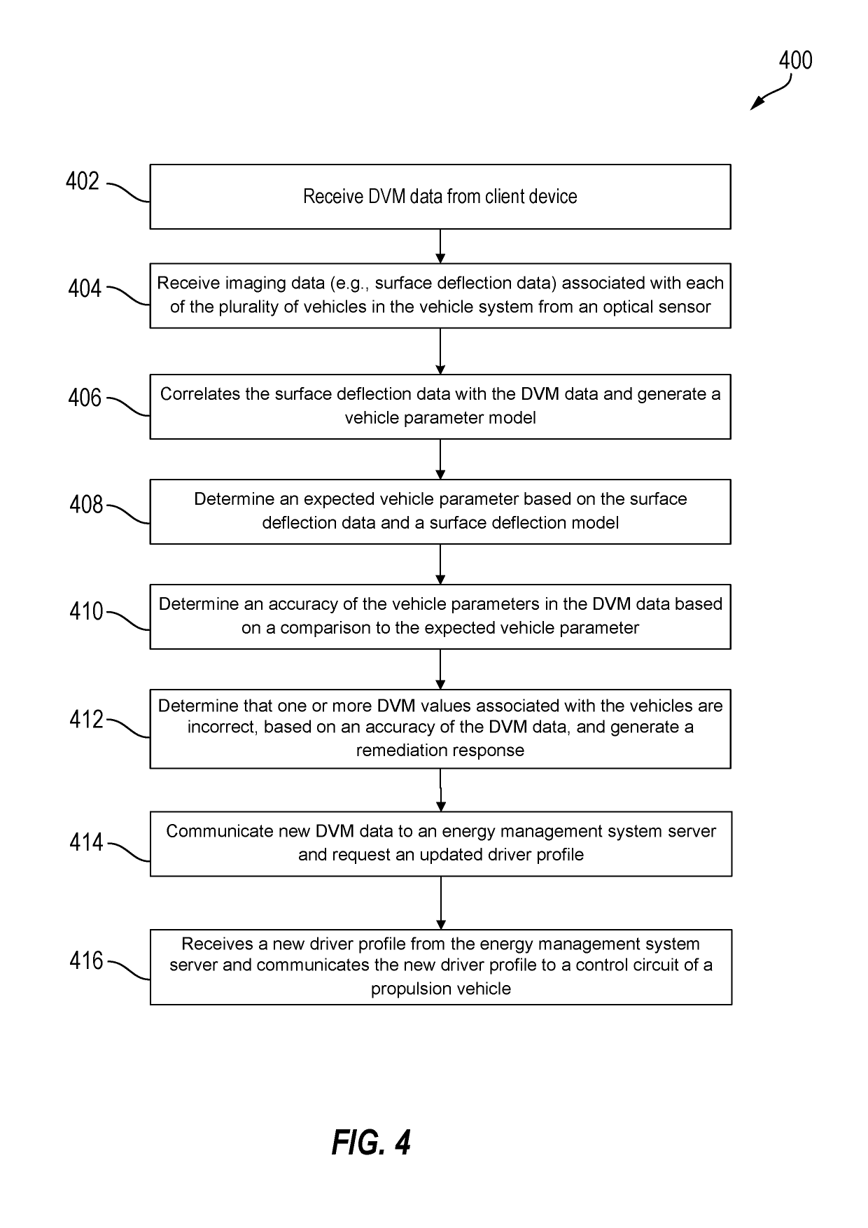

FIG. 4 shows a logic flow diagram 400 for evaluating the accuracy of DVM data based on imaging data observed on a vehicle system 120, according to at least one aspect of the present disclosure. The vehicle management server 104 receives 402 a detailed vehicle makeup (DVM) data from the client device 102, where the DVM data comprises a vehicle parameter (e.g., vehicle weight or load status) for a plurality of vehicles 202a-n in the vehicle system 120. The vehicle management server 104 receives 404 imaging data (e.g., surface deflection data) associated with each of the plurality of vehicles 202a-n in the vehicle system 120 from an optical sensor (e.g., wayside device 108). The optical sensor 108 may capture surface deflection data associated with a vehicle weight or loading status for each of the vehicles in the vehicle system 120. The vehicle management server 104 correlates 406 the imaging data with the DVM data and generates a vehicle parameter model. The vehicle management server 104 determines 408 an expected vehicle parameter (e.g., vehicle weight, vehicle load status, vehicle position) for the plurality of vehicles based on the surface deflection data and a surface deflection model. The vehicle parameter model (e.g., surface deflection model) may be continuously updated based on the received imaging data and the DVM data. In one embodiment, the model first identifies outlier data and removes these data points from a training epoch allowing a subsequent iteration of the model to generate an expected value at a higher degree of accuracy. The vehicle management server 104 determines 410 an accuracy of the vehicle parameters in the DVM data, for the plurality of vehicles, based on a comparison of the expected vehicle parameter in a range (statistical threshold) to the vehicle parameters in the DVM data. The vehicle management server 104 may determine 412 that based on a calculated accuracy of the DVM data, that one or more values associated with the vehicles are incorrect and generates a remediation response. The vehicle management server 104 may notify (e.g., remediation responses) the client device 102 of the identified error values, suggest replacement values, and/or request new DVM data. The vehicle management server 104 may automatically generate (e.g., remediation responses) new DVM data based on a generative model that replaces the identified error values. The vehicle management server 104 communicates 414 the new DVM data to an energy management system server 112 and requests an updated driver profile. The vehicle management server 104 receives 416 a new driver profile from the energy management system server 112 and communicates the new driver profile to a control circuit of a propulsion vehicle in the vehicle system.

Examples of the methods and systems disclosed herein, according to various aspects of the present disclosure, are provided below in the following embodiments. An aspect of the method may include any one or more than one of, and any combination of, the embodiments described below.

In a first embodiment a system comprises a sensor configured to capture vehicle imaging data indicative of a vehicle parameter for a plurality of vehicles; a control circuit for communicating with the sensor. The control circuit is configured to receive detailed vehicle makeup (DVM) data associated with the plurality of vehicles, receive the vehicle imaging data from the sensor; determine an expected vehicle parameter for at least one of the plurality of vehicles based on the vehicle imaging data and a vehicle parameter model, compare the expected vehicle parameter to the DVM data for a corresponding vehicle, and determine an accuracy of the vehicle parameter in the DVM data based on the comparison of the expected vehicle parameter to the DVM data.

In one aspect of the first embodiment, the accuracy of the vehicle parameter in the DVM data is determined based on the comparison of the expected vehicle parameter to a statistical threshold of the vehicle parameter in the DVM data. Additionally, the control circuit is further configured to generate updated DVM data, based on the expected vehicle parameter exceeding the statistical threshold of the vehicle parameter in the DVM data, wherein the updated DVM data replaces the vehicle parameter with the expected vehicle parameter; and generate a notification based on the expected vehicle parameter exceeding the statistical threshold of the vehicle parameter in the DVM data, wherein the notification comprises the updated DVM data, or transmit a request to update a driver profile based on the updated DVM data, wherein the driver profile is updated to modify an operational parameter of at least one of the plurality of vehicles in a vehicle system.

In another aspect of the first embodiment, which may be combined with one or more aspects of the first embodiment, the control circuit is further configured to calibrate the vehicle parameter model, based on aggregated data for the plurality of vehicles and the DVM data for the plurality of vehicles.

In another aspect of the first embodiment, which may be combined with one or more aspects of the first embodiment, the vehicle parameter model determines the expected vehicle parameter as a weight value, proportional to a measured surface deflection.

In another aspect of the first embodiment, which may be combined with one or more aspects of the first embodiment, the sensor comprises a wayside device positioned vertically in-line with a vehicle infrastructure surface, and wherein the wayside device is configured to measure surface deflections of the vehicle infrastructure surface of the plurality of vehicles.

In another aspect of the first embodiment, which may be combined with one or more aspects of the first embodiment, the vehicle parameter comprises at least one of: a vehicle weight, a load status, a vehicle order of the plurality of vehicles, or any combination thereof.

In a second embodiment a method begins by receiving detailed vehicle makeup (DVM) data, wherein the DVM data comprises vehicle load data for a plurality of vehicles. The method continues by receiving vehicle imaging data from a wayside device, wherein the wayside device is configured to capture the vehicle load data for the plurality of vehicles, determining an expected vehicle load for the plurality of vehicles based on the vehicle imaging data and a vehicle parameter model, and determining an accuracy of the vehicle load data in the DVM data based on a comparison to the expected vehicle load.

In one aspect of the second embodiment, the method continues by determining the accuracy of the vehicle load data in the DVM data by comparing the expected vehicle load to a statistical threshold of the vehicle load data in the DVM data, generating updated DVM data, based on the expected vehicle load exceeding the statistical threshold of the vehicle load data in the DVM data, wherein the updated DVM data replaces the vehicle load data with the expected vehicle load for the plurality of vehicles; and generating a notification based on the expected vehicle load exceeding the statistical threshold of the vehicle load data, wherein the notification comprises the updated DVM data, and/or transmitting a request to update a driver profile based on the updated DVM data.

In another aspect of the second embodiment, which may be combined with one or more aspects of the second embodiment, the method continues by determining, by the wayside device, the vehicle imaging data as a surface deflection of a vehicle infrastructure surface and corresponding to the plurality of vehicles, wherein the wayside device is positioned vertically in-line with the vehicle infrastructure surface, and determining the expected vehicle load with the vehicle parameter model as a weight, value proportional to the surface deflection.

In a third embodiment a method begins by receiving detailed vehicle makeup (DVM) data, wherein the DVM data comprises a vehicle weight for a plurality of vehicles. The method continues by receiving surface deflection data from a wayside device, wherein the wayside device is configured to capture the surface deflection data indicative of the vehicle weight, determining an expected vehicle weight for the plurality of vehicles based on the surface deflection data and a surface deflection model, and determining an accuracy metric of the vehicle weight in the DVM data for the plurality of vehicles based on the expected vehicle weight and a statistical threshold of the vehicle weight in the DVM data.

In one aspect of the third embodiment, the method continues by determining a first vehicle of the plurality of vehicles is empty based on the accuracy metric of the vehicle weight in the DVM data, wherein the accuracy metric indicates that the DVM data incorrectly identifies the first vehicle as loaded, and generating a notification to an energy management system that the DVM data incorrectly identifies the first vehicle as loaded, wherein the notification comprises updated DVM based on the expected vehicle weight.

In various aspects, one or more systems (e.g., control system) in the communication network may process data using artificial intelligence or machine learning. The communication network includes a local data collection system deployed that may use machine learning to enable derivation-based learning outcomes. The communication network may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December, 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

This written description uses examples to disclose several embodiments of the inventive subject matter and also to enable a person of ordinary skill in the art to practice the embodiments of the inventive subject matter, including making and using any devices or systems and performing any incorporated methods. The patentable scope of the inventive subject matter is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A system, comprising:
a sensor configured to capture vehicle imaging data indicative of a vehicle parameter for a plurality of vehicles;
a control circuit for communicating with the sensor, wherein the control circuit is configured to:
receive detailed vehicle makeup (DVM) data associated with the plurality of vehicles;
receive the vehicle imaging data from the sensor;
determine an expected vehicle parameter for at least one of the plurality of vehicles based on the vehicle imaging data and a vehicle parameter model;
compare the expected vehicle parameter to the DVM data for a corresponding vehicle; and
determine an accuracy of the vehicle parameter in the DVM data based on the comparison of the expected vehicle parameter to the DVM data.

2. The system of claim 1, wherein the accuracy of the vehicle parameter in the DVM data is determined based on the comparison of the expected vehicle parameter to a statistical threshold of the vehicle parameter in the DVM data.

3. The system of claim 2, wherein the control circuit is further configured to:
generate updated DVM data, based on the expected vehicle parameter exceeding the statistical threshold of the vehicle parameter in the DVM data, wherein the updated DVM data replaces the vehicle parameter with the expected vehicle parameter.

4. The system of claim 3, wherein the control circuit is further configured to:
generate a notification based on the expected vehicle parameter exceeding the statistical threshold of the vehicle parameter in the DVM data, wherein the notification comprises the updated DVM data.

5. The system of claim 3, wherein the control circuit is further configured to:
transmit a request to update a driver profile based on the updated DVM data.

6. The system of claim 5, wherein the driver profile is updated to modify an operational parameter of at least one of the plurality of vehicles in a vehicle system.

7. The system of claim 1, wherein the control circuit is further configured to:
calibrate the vehicle parameter model, based on aggregated data for the plurality of vehicles and the DVM data for the plurality of vehicles.

8. The system of claim 1, wherein the vehicle parameter model determines the expected vehicle parameter as a weight value, proportional to a measured surface deflection.

9. The system of claim 1, wherein the sensor comprises a wayside device positioned vertically in-line with a vehicle infrastructure surface, and wherein the wayside device is configured to measure surface deflections of the vehicle infrastructure surface of the plurality of vehicles.

10. The system of claim 1, wherein the vehicle parameter comprises at least one of: a vehicle weight, a load status, a vehicle order of the plurality of vehicles, or any combination thereof.

11. A method comprising:
receiving detailed vehicle makeup (DVM) data, wherein the DVM data comprises vehicle load data for a plurality of vehicles;
receiving vehicle imaging data from a wayside device, wherein the wayside device is configured to capture the vehicle load data for the plurality of vehicles;
determining an expected vehicle load for the plurality of vehicles based on the vehicle imaging data and a vehicle parameter model; and
determining an accuracy of the vehicle load data in the DVM data based on a comparison to the expected vehicle load.

12. The method of claim 11, further comprising:
determining the accuracy of the vehicle load data in the DVM data by comparing the expected vehicle load to a statistical threshold of the vehicle load data in the DVM data.

13. The method of claim 12, further comprising:
generating updated DVM data, based on the expected vehicle load exceeding the statistical threshold of the vehicle load data in the DVM data, wherein the updated DVM data replaces the vehicle load data with the expected vehicle load for the plurality of vehicles.

14. The method of claim 13, further comprising:
generating a notification based on the expected vehicle load exceeding the statistical threshold of the vehicle load data, wherein the notification comprises the updated DVM data.

15. The method of claim 13, further comprising:
transmitting a request to update a driver profile based on the updated DVM data.

16. The method of claim 11, further comprising:
determining, by the wayside device, the vehicle imaging data as a surface deflection of a vehicle infrastructure surface and corresponding to the plurality of vehicles, wherein the wayside device is positioned vertically in-line with the vehicle infrastructure surface.

17. The method of claim 16, further comprising:
determining the expected vehicle load with the vehicle parameter model as a weight, value proportional to the surface deflection.

18. A method comprising:
receiving detailed vehicle makeup (DVM) data, wherein the DVM data comprises a vehicle weight for a plurality of vehicles;
receiving surface deflection data from a wayside device, wherein the wayside device is configured to capture the surface deflection data indicative of the vehicle weight;
determining an expected vehicle weight for the plurality of vehicles based on the surface deflection data and a surface deflection model; and
determining an accuracy metric of the vehicle weight in the DVM data for the plurality of vehicles based on the expected vehicle weight and a statistical threshold of the vehicle weight in the DVM data.

19. The method of claim 18, further comprising:
determining a first vehicle of the plurality of vehicles is empty based on the accuracy metric of the vehicle weight in the DVM data, wherein the accuracy metric indicates that the DVM data incorrectly identifies the first vehicle as loaded.

20. The method of claim 19, further comprising:
generating a notification to an energy management system that the DVM data incorrectly identifies the first vehicle as loaded, wherein the notification comprises updated DVM based on the expected vehicle weight.
